(19) United States
(12) Patent Application Publication
(10) Pub. No.: US 2020/0118447 A1
(43) Pub. Date: Apr. 16, 2020

(54) AVIONIC INFORMATION SYSTEM

(71) Applicant: HONEYWELL INTERNATIONAL INC., Morris Plains, NJ (US)

(72) Inventor: Sushma Gowda, Bangalore (IN)

(73) Assignee: HONEYWELL INTERNATIONAL INC., Morris Plains, NJ (US)

(21) Appl. No.: 16/160,322

(22) Filed: Oct. 15, 2018

(51) Int. Cl. G08G 5/00; G01C 23/00

(52) U.S. Cl. CPC G08G 5/0047; G01C 23/005; G08G 5/0039

(57) ABSTRACT

Avionic information systems are disclosed herein. The avionic information system includes a flight management system for providing a current designated waypoint. The avionic information system also includes a navigation database storing waypoint location information and airway location information and a display module. The avionic information system also includes a processor module operably connected to the flight management system, the navigation database and the display. The processor is configured to determine, from the stored waypoint location information and the stored airway location information, one or more airways that are connected to the current designated waypoint and to cause the display module to graphically represent the current designated waypoint and only the determined one or more airways that are connected to the current designated waypoint and not other nearby airways. Methods of using such systems are also disclosed herein.

### TECHNICAL FIELD

The present disclosure generally relates to avionic information systems, and more particularly relates to an avionic information system including a flight management system.

### BACKGROUND

Flight management systems (FMS) are commonly used in modern aircraft. An FMS is a computerized system that allows for various pilot tasks to be performed automatically or to assist the pilot in performing certain tasks.

One pilot task for which the FMS may assist the pilot is the management of the flight plan of the aircraft during the aircraft's flight. An aircraft's flight plan is generally pre-determined before aircraft take-off. However, the flight plan may be modified by a pilot mid-flight for various reasons. For example, the pilot may wish to re-route the aircraft during the flight in reaction to severe weather or airway congestion or simply to utilize a more efficient route.

Typically, the FMS includes a navigation database that stores various information related to the aircraft's surrounding environment and the aircraft's pre-determined flight plan, such as waypoint information and airway information about the waypoints and airways making up the flight plan. As used herein, an “airway” is defined in its conventional sense to mean a designated flight path to which an aircraft should adhere when travelling in that airspace. An airway is normally defined between, or traversing, two or more waypoints. As is known in the art, a “waypoint” typically corresponds to a known aircraft beacon or geographic feature with which pilots are familiar, but this is not always the case. The FMS generally also includes a terrain database (which may or may not be a separate database to the navigation database) which includes terrain information such as the location and size of obstacles, geographical landmarks, and so on.

Modern FMS systems are able to graphically represent all waypoints and airways within a certain distance from the aircraft on a display. However, since there are typically a large number of airways and waypoints in and around any given area of airspace, the display can normally only show a limited range of these airways and waypoints at an acceptable resolution. This displayed limited range is normally about 50 nautical miles from the aircraft's present position.

If the display were to instead show airways and waypoints within a larger range, for example 100 nautical miles from the aircraft's position, the display would be too cluttered with information and/or the resolution of the display would be too small, and the pilot would then have difficulty in locating a particular waypoint or airway on the display. This increased difficulty would lead to an increase in pilot “head-down” time and an associated decrease in the pilot's situational awareness. In particular, a large amount of pilot time and effort may be devoted to identifying certain information shown on the representation, such as aircraft entry and exit points to a particular airway, and then entering this data into the FMS when a flight plan modification is required. The correct identification and subsequent entry of airway and waypoint information into the FMS when modifying the flight plan is important in order for the aircraft to traverse a safe and fuel-efficient route from one destination to another.

Accordingly, it would be desirable to increase the effective range that can be displayed on the graphical display without increasing pilot workload. Other desirable features and characteristics will become apparent from the subsequent detailed description and appended claims.

### BRIEF SUMMARY

This summary is provided to introduce a selection of concepts in a simplified form that are further described below in the detailed description section.

In an exemplary embodiment, there is provided an avionic information system. The avionic information system includes a flight management system for providing a current designated waypoint. The avionic information system also includes a navigation database storing waypoint location information and airway location information and a display module. The avionic information system also includes a processor module operably connected to the flight management system, the navigation database and the display. The processor is configured to determine, from the stored waypoint location information and the stored airway location information, one or more airways that are connected to the current designated waypoint and to cause the display module to graphically represent only the current designated waypoint and the determined one or more airways that are connected to the current designated waypoint and to not display other nearby airways.

In another exemplary embodiment, there is provided a method of modifying a pre-determined flight plan. The method includes the step of graphically representing, using a processor module, a current designated waypoint and only airways that are connected to the current designated waypoint, and not other nearby airways. The method also includes the step of selecting, using a flight management system, an airway connected to the current designated waypoint. The method also includes the step of displaying, using the processor module, a list of potential subsequent designated waypoints and a graphical representation of the subsequent designated waypoints. The method also includes the step of selecting a subsequent designated waypoint from the list of potential subsequent designated waypoints.

### BRIEF DESCRIPTION OF THE DRAWINGS

A more complete understanding of the subject matter may be derived from the following detailed description taken in conjunction with the accompanying drawings, wherein like reference numerals denote like elements, and wherein:

FIG. 1 shows a graphical representation of a conventional flight management system;

FIG. 2 shows a representative airway dialog box to be displayed concurrently with a representation in accordance with exemplary embodiments;

FIG. 3 shows a functional block diagram of an avionic information system in accordance with exemplary embodiments;

FIG. 4 shows a graphical representation in accordance with exemplary embodiments;

FIG. 5 shows another graphical representation in accordance with exemplary embodiments;

FIG. 6 shows another graphical representation, displayed together with an associated airway vertical profile, in accordance with exemplary embodiments;

FIG. 7 shows a representative dialog box in accordance with exemplary embodiments;

FIG. 8 shows another representative dialog box in accordance with exemplary embodiments;

FIGS. 9 and 10 show another representative dialog box in accordance with exemplary embodiments; and

FIG. 11 shows a flowchart of a method in accordance with exemplary embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the systems and methods defined by the claims. As used herein, the term “module” refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. There is no intention to be bound by any expressed or implied theory presented in the preceding Technical Field, Background, Brief Summary or the following Detailed Description.

For the sake of brevity, conventional techniques and components may not be described in detail herein. Furthermore, any connecting lines and arrows shown in the various figures contained herein are intended to represent example functional relationships and/or physical couplings between the various elements. It should be noted that many alternative or additional functional relationships or physical connections may be present in an embodiment of the present disclosure.

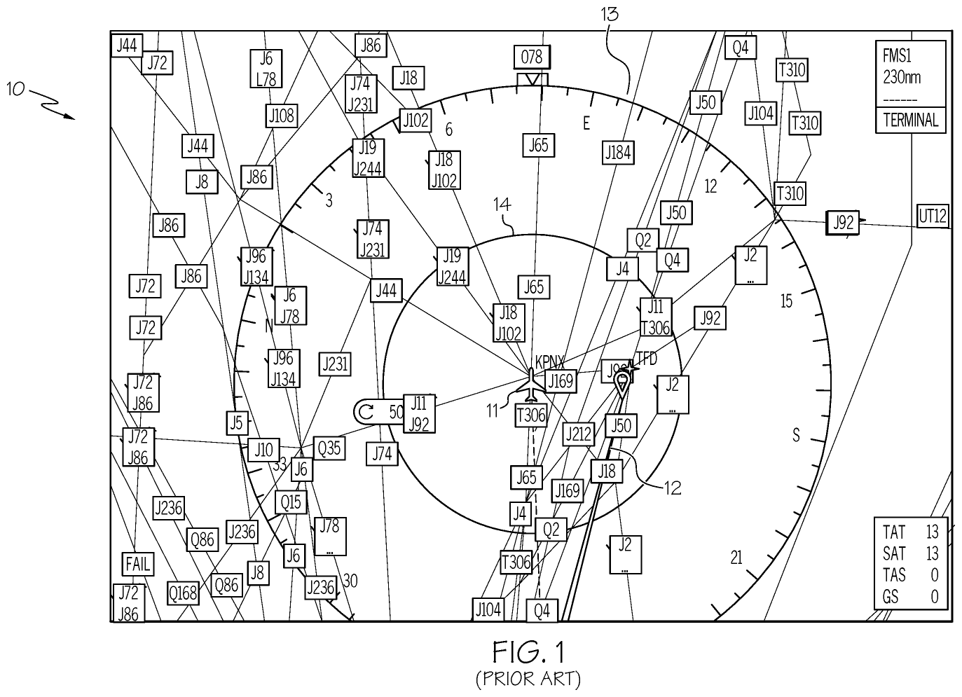

FIG. 1 shows a representation 10 displayed on a graphical display of a conventional flight management system. In the representation 10, the aircraft's present position and flight direction is indicated through the use of a marker 11. Various waypoints 12 and airways 13 (shown here using thin solid lines) are shown on the representation 10, with each airway 13 being located between or traversing one or more waypoints 12. In some representations, the marker 11, waypoints 12 and airways 13 may be superimposed over a colored graphic (not shown), the colors of which graphic represent different types of terrain.

The representation 10 in FIG. 1 shows all waypoints 12 and airways 13 within a range of about 50 nautical miles (nm) from the aircraft's present position as designated by the marker 11. This range is illustrated via the use of a ranging circle 14, which is representative of a 50 nm radius circle surrounding the aircraft's present position. As can be seen in FIG. 1, the conventional representation 10 is cluttered with airway and waypoint information, and it can be difficult for a pilot to locate a particular waypoint or airway on the conventional representation 10. Furthermore, with the range of the representation being about 50 nm, the pilot is unable to easily locate airways 13 and waypoints 12 that are located more than 50 nm away from the aircraft's present position.

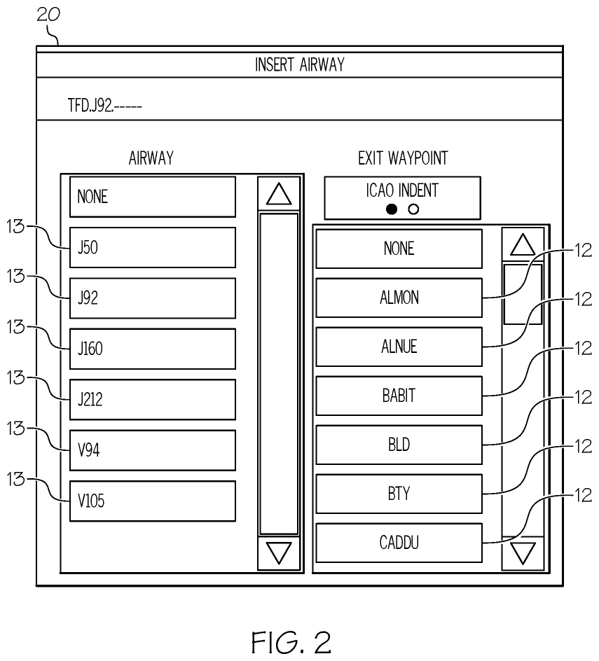

FIG. 2 shows an exemplary dialog box 20 that may be used to modify a flight plan using a flight management system (FMS). In conventional use, a pilot may interact with a flight management system of the aircraft to display the dialog box 20. In a conventional system, the dialog box 20 would be overlaid on top of the representation 10 shown in FIG. 1. After the dialog box 20 is displayed overlaid on the representation 10, the pilot would then be able to modify the flight plan by selecting a subsequent airway 13 which is different to the airway specified in the pre-determined flight plan from the list of subsequent airways 13, and also by selecting one exit waypoint 12 by which to exit the selected airway from the displayed list of exit waypoints 12.

In particular, as can be seen in FIG. 2, multiple airways 13 are listed in the dialog box 20. The pilot is able to select one particular airway 13 in order to modify the flight plan so as to replace the subsequent airway forming part of the pre-determined flight plan with the selected airway 13. Additionally, as can also be seen in FIG. 2, multiple exit waypoints 12 are also listed in the dialog box 20. Each one of these multiple exit waypoints 12 corresponds to an exit waypoint of at least one of the listed airways 13. As such, the pilot is able to select a certain exit waypoint 12 by which to exit the selected airway 13.

However, in conventional systems, although the dialog box 20 lists potential subsequent airways 13 and potential exit waypoints 12, the pilot is not able to easily determine which exit waypoint 12 corresponds to the exit point of each airway 13. In particular, the pilot may have to “switch” between views of the dialog box 20 and the representation 10 (over which the dialog box 20 is displayed) in order to determine which exit waypoint 12 is associated with each potential subsequent airway 13. This “switching” process increases the pilot's workload and the time taken to modify the flight plan.

Furthermore, because the dialog box 20 is overlaid on top of the representation 10 and thereby obscures the pilot's view of the airways 13 and waypoints 12 shown on the representation 10, the manner in which this information is viewed by the pilot increases the difficulty for the pilot in modifying the flight plan. In some situations, the pilot may have to remember which airways 13 and waypoints 12 are associated with each other when selecting the various airways 13 and waypoints 12 in the dialog box 20, because the pilot is unable to view the obscured information displayed on the representation 10. This necessity to memorize certain pieces of information increases the burden on the pilot when performing flight plan modifications.

In order to overcome the above-described disadvantages, exemplary embodiments of the invention present a reduced amount of information to the pilot.

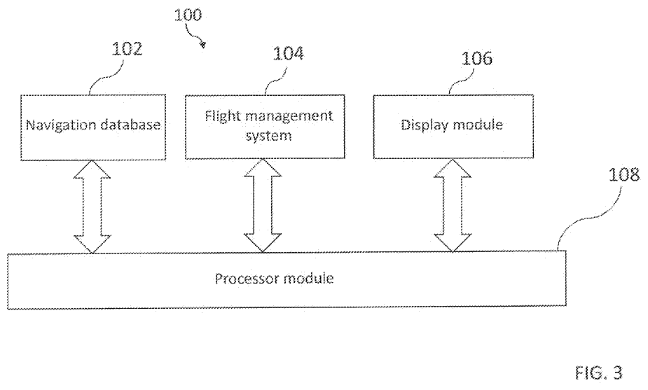

FIG. 3 shows a functional schematic of an avionic information system 100 in accordance with various embodiments. Outlined arrows in this figure are used to show operable connections between the various elements shown in this figure.

In exemplary embodiments, the avionic information system 100 includes a navigation database 102. The navigation database 102 is configured to store information relating to the location of various waypoints 12 and the airways 13 connecting these waypoints 12. As defined herein, the terms “connecting” or “connected to” are used to mean that an airway crosses a particular waypoint or joins that particular waypoint. The navigation database 102 may also include terrain information, or a separate terrain database may be provided.

The avionic information system 100 further includes a flight management system 104. The flight management system 104 is configured to store a pre-determined flight plan, which includes a pre-determined number of designated waypoints 12 and designated airways 13 along which the aircraft was originally planned to travel.

Based on the aircraft's present location and the pre-determined flight plan, the flight management system 104 is configured to provide a current designated waypoint. The current designated waypoint is the waypoint to which the aircraft is presently travelling, typically along an airway.

In various exemplary embodiments, the flight management system 104 is operable for pilot interaction to modify the pre-determined flight plan. For example, in various embodiments, the flight management system 104 includes an input/output (I/O module) configured to receive pilot input, for example through the use of a keyboard and mouse, joystick, or other such input device as known in the art, and also to provide an output, for example via a printer or other such output device as known in the art.

As will be explained in more detail below, the pilot may interact with the flight management system 104 to change the current designated waypoint in order to modify the pre-determined flight plan. More specifically, the pilot may interact with the flight management system 104 to de-select the current designated waypoint and to select a different waypoint to become the current designated waypoint. Furthermore, the pilot may interact with the flight management system 104 to de-select a subsequent planned airway 13 and select a new subsequent airway 13.

In exemplary embodiments, the avionic information system 100 includes a display module 106. The display module 106 is operable to graphically display a representation (not shown in this figure) of the current designated waypoint and airways that are connected to the current designated waypoint, as will be explained in more detail below.

In exemplary embodiments, the avionic information system further includes a processor module 108. The processor module 108 is operably connected to the navigation database 102, the flight management system 104 and the display module 106. The processor module 108 is configured to determine, on the basis of the current designated waypoint and the waypoint and airway location information, which airways are connected to the current designated waypoint and to cause the display module 106 to graphically represent only those airways that are connected to the current designated waypoint.

By graphically representing only those airways that are determined to be connected to the current designated waypoint, and not representing other airways near to the location of the aircraft, less airway information can be graphically represented on the display module 106 as compared to conventional representations. As such, the amount of unnecessary airway information displayed to the pilot can be reduced, and the amount of “clutter” displayed on the display module 106 can also be reduced accordingly. The man-machine interface between the pilot and the avionic information system 100 is therefore improved, since the amount of pilot effort needed to locate and selecting a particular subsequent airway or waypoint airway is reduced. Importantly, airway and/or waypoint information that may otherwise have been obscured by airway and/or waypoint information on conventional representations is not obscured on the representation according to various exemplary embodiments due to the reduced amount of clutter on the representation.

Furthermore, since the amount of “clutter” presented to the pilot is reduced on the display module 106, the display module 106 may graphically represent airway location information over a larger effective range from the aircraft's present position as compared to conventional flight management systems. In particular, a larger range may be represented on the display module 106 because the reduced information represented on the display module 106 means that airway and waypoint information is less likely to overlap/overpost with other each other, even when the airway and waypoint information is shown over larger ranges from the aircraft's present position.

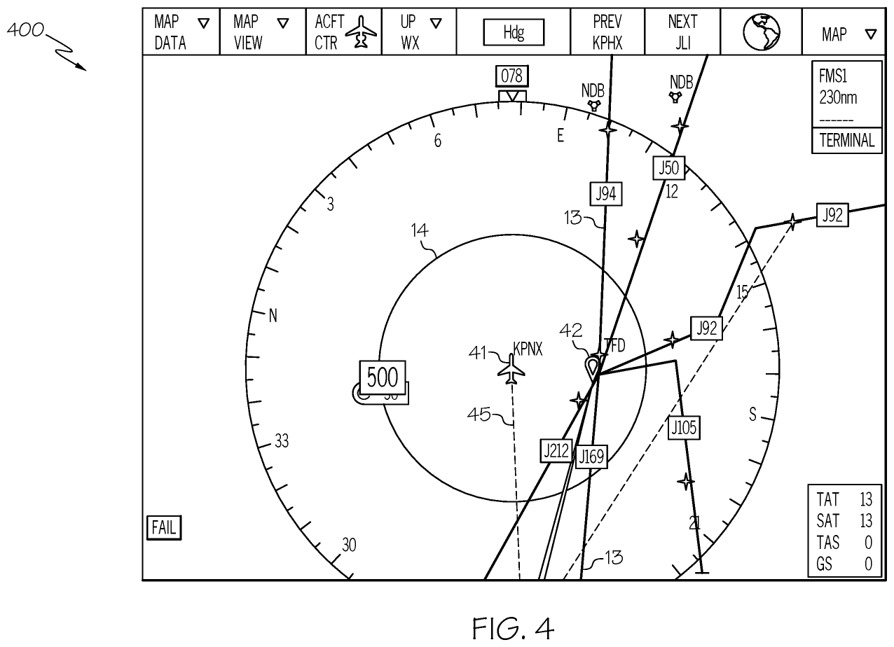

An exemplary representation 400 in accordance with various embodiments is shown in FIG. 4. As can be seen in FIG. 4, in the representation 400, the aircraft's present position and current flight direction is indicated through the use of a marker 41. The current designated waypoint 42 (waypoint “TFD”) is graphically represented, and airways 13 (shown through the use of solid lines) which have been determined to be connected to the current designated waypoint 42 are also shown on the representation 400. In some representations, the marker 41, current designated waypoint 42 and airways 13 connected to the current designated waypoint 42 may be shown superimposed over a colored graphic (not shown) which represents terrain information. In exemplary embodiments, the terrain information has a color corresponding to the terrain under the aircraft's present position (for example, blue if the aircraft is presently positioned over a body of water or green if the aircraft is presently position over a land mass).

In exemplary embodiments, the representation 400 includes a divergence line 45 showing the divergence between the aircraft's present path of travel and the airway 13 upon which the aircraft is supposed to be traversing.

Comparing the representation 400 in accordance with various embodiments as shown in FIG. 4 to the conventional representation 10 shown in FIG. 1, it is immediately apparent that there is less information presented to the pilot in the representation 400. The reduced amount of information represented in the representation 400 is nevertheless all that is required for the pilot to make a decision about which airway 13 to select as being the subsequent airway along which the aircraft will traverse once the aircraft reaches the current designated waypoint 42.

Since less information is presented on the exemplary representation 400 in accordance with various embodiments as compared to the conventional representation 10, the representation 400 in accordance with various embodiments can show information over a larger effective range than the conventional representation 10. As explained above, conventional representations 10 are limited to displaying an area of about 50 nm from the aircraft's present location due to the increased clutter and resolution issues encountered at larger effective ranges.

In contrast, in the exemplary representation 400, the reduced information presented allows for a larger effective range from the aircraft's present location to be displayed. The representation 400 show in FIG. 4 shows airway information over an effective range of about 500 nm from the aircraft's present position, as shown via the ranging circle 14. In various exemplary embodiments, the representation may display airway information over an effective range of over about 1000 nm from the aircraft's present position, for example about 750 nm from the aircraft's present position.

Displaying airway information over a larger effective range to the pilot is advantageous in terms of pilot workload, since a greater amount of one particular airway 13 can be displayed to the pilot on the exemplary representation 400 as compared to conventional representations 10. For example, if a particular airway 13 has a sharp turn located at a point in the airway 13, which sharp turn would require maneuvering of the aircraft, this sharp turn is more likely to be shown in the representation 400 in accordance with various embodiments than the conventional representation 10 due to the increased effective range of the representation 400 in accordance with various embodiments. As such, the pilot is forewarned about the sharp turn and associated maneuvering of the aircraft earlier with the avionic information system according to various embodiments as compared to conventional representations, thereby increasing the pilot's situational awareness and reducing pilot workload.

Still further, yet another problematic issue associated with conventional representations 10 is that the airway 13 and waypoint 12 information can overpost or otherwise obscure other types of information shown on the representation 10, such as terrain information, weather information or traffic information, which can be selectively displayed by the pilot through interaction with the FMS. This can lead to the pilot having to selectively “switch-off” the airway information in order to view the other types of information, which operation requires additional pilot effort and an associated increase in pilot “head-down” time, thereby reducing situational awareness.

In contrast, with the representation 400 in accordance with exemplary embodiments, the reduced airway information means that the airway information is less likely to overpost or otherwise obscure the other types of information that may be displayed on the representation 400, thereby reducing pilot “head-down” time.

Still further, since the airway information shown on the representation 400 is reduced, the displaying of a dialog box 20 for selecting subsequent airways 12 and waypoints on the representation 400 is less likely to obscure airway information. This means the pilot is able to easily cross-reference the airway information shown on the representation 400 with the options shown in the dialog box 20 without needing to “switch” between the view of the dialog box 20 and the view of the representation 400.

In exemplary embodiments, the processor module 108 is configured to, in reaction to the pilot interacting with the flight management system 102 to call up the dialog box 20, determine a location on the representation 400 where the dialog box does not obscure any airway information. For example, the processor module 108 determines the X, Y positions of each pixel forming an airway or waypoint on the display module 106, and then select a location on the display module 106 for displaying the dialog box 20 that does not cover any of these determined X, Y positions.

As the dialog box 20 does not obscure the airway information displayed on the representation 400, the pilot is able to use the waypoint and airway information graphically displayed on the representation 400 concurrently with the information in the dialog box 20, to thereby have a visual aid when selecting subsequent airways 13 and exit waypoints 12 from the lists in the dialog box 20.

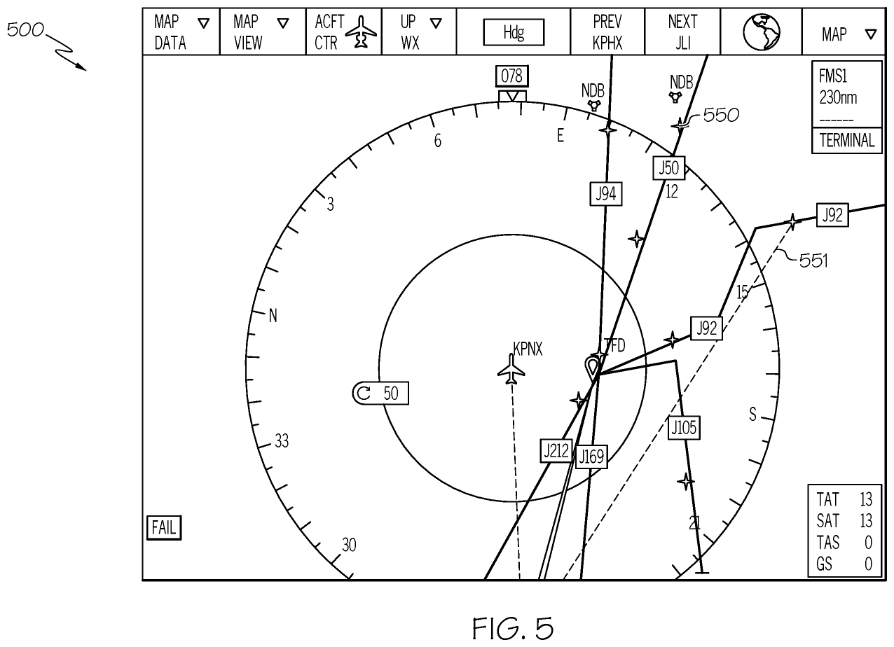

Another exemplary representation 500 in accordance with various embodiments is shown in FIG. 5. As can be seen in FIG. 5, the representation 500 includes a series of navigational aids 550. In various exemplary embodiments, the navigational aids 550 include one of more navigational aids selected from the group comprising: a previous waypoint identifier, a subsequent waypoint identifier, a distance identifier, a present aircraft altitude identifier, and so on. In various embodiments, the pilot may interact with the flight management system 104 to display additional information about the navigational aids 550 on the display. As discussed above, the reduced airway and waypoint information displayed on the representation 500 reduces the likelihood that any of this information would obscure the additional navigational aid information displayed in reaction to pilot selection. The navigational aids 550 therefore assist the pilot in finding the location of certain elements, such as exit waypoints, on the representation.

One additional disadvantage associated with conventional representations 10 is that the exit points from each airway are not normally clearly displayed on the representation 10. As used herein, an “exit point” defines a designated location where an aircraft may exit an airway, for example when traversing between airways and/or waypoints. In particular, an exit point from an airway is normally an exit waypoint. In conventional systems, exit points are typically only displayed in a dialog box that can be temporarily displayed by the pilot. The lack of a graphical representation of the exit points close to a particular waypoint may cause the pilot to plan a longer or otherwise less efficient route than may be required, or may add an additional workload onto the pilot when the pilot is performing the task of selecting multiple exit points along the overall flight plan.

Representations according to exemplary embodiments overcome this issue. In particular, the representation 500 includes a “direct route” navigational aid 551 which graphically displays a direct route to a selected exit point on a potential subsequent airway from the present airway along which the aircraft is travelling. In this manner, the pilot is able to easily visualize the direct route from a present position to a selected exit point.

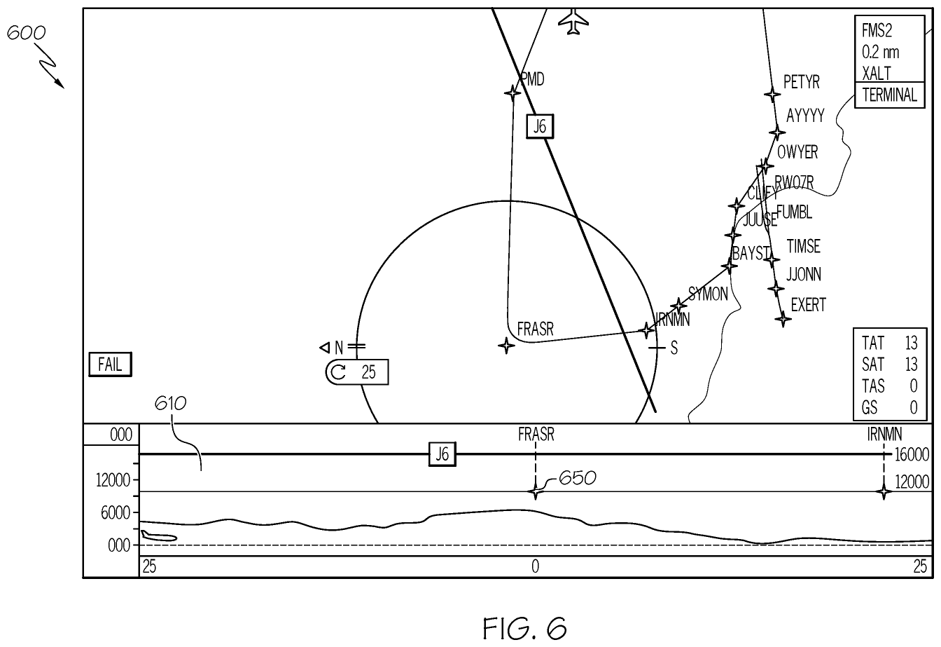

In exemplary embodiments, the pilot is able to operate the flight management system 104 to display additional information about a selected exit point or selected airway. An example of such additional information can be seen in FIG. 6, which shows a representation 600 together with an airway vertical profile 610 of the selected exit point and associated airway. As can be seen in FIG. 6, the airway vertical profile 610 shows the altitude of the airway containing the selected exit point 650. The airway vertical profile 610 assists the pilot in visualizing said airway, and also shows the altitude of terrain surrounding the exit point. The airway vertical profile may assist the pilot in determining whether aircraft maneuvers are required to reach the exit point or whether unusual terrain (such as high mountains) exist around the exit point 650.

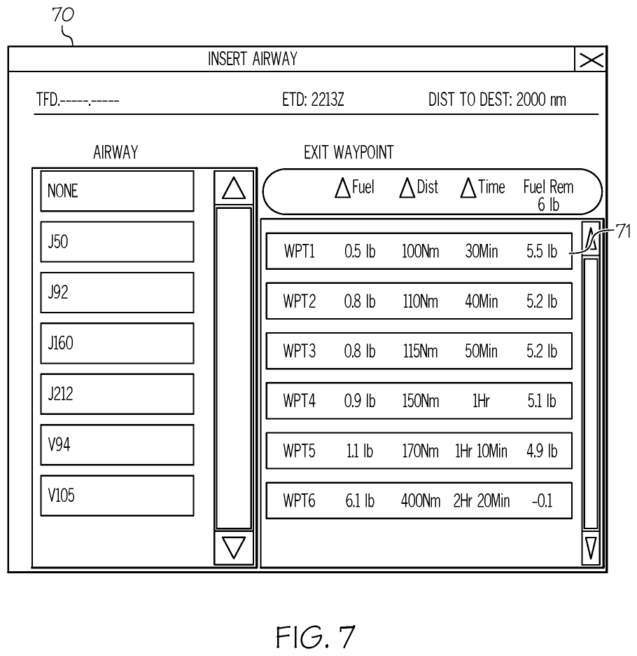

FIG. 7 shows another aspect of exemplary embodiments. In particular, FIG. 7 shows a dialog box 70 that is displayed when the pilot interacts with the fight management system 104 in order to select a particular exit point. In exemplary embodiments, the dialog box 70 is displayed concurrently with the representation 100. The dialog box 70 shows performance data 71 associated with the selected exit point as obtained from the navigation database 102. The performance data 71 may include the amount of time needed to reach the selected exit point, the amount of fuel needed to reach the selected exit point and/or the distance to the selected exit point from the aircraft's present position. Furthermore, the processor module 108 is configured to calculate similar performance data for other exit points close to the selected waypoint based on data from the navigation database 102. The pilot is able to select, using the flight management system 104, a series of exit points, and a comparison of the performance data for each selected exit point is shown in the dialog box 70.

The dialog box 70 may be displayed in a similar manner to the dialog box 20, such that the dialog box 70 does not obscure information shown on the representation 400. In this manner, the pilot is able to compare and contrast performance data for each potential exit point and can select a desirable exit point with the benefit of the information shown on both of the graphical representation 400 and also the dialog box 70 without “switching” between these two different sources of information. For example, the pilot is able to assess, on the basis of the performance data shown in the dialog box 70, whether enough fuel remains in the aircraft fuel tanks to reach a specific selected exit point shown on the graphical representation.

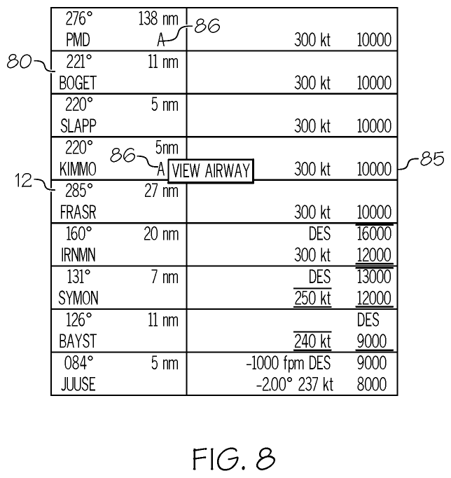

In various exemplary embodiments, additional airway information may be shown in a waypoint selection dialog box. FIG. 8 shows a dialog box 80 containing a list of selectable waypoints 12. Waypoint information 85, such as the present distance of the waypoint from the aircraft, is also shown in the dialog box 80.

Also shown in FIG. 8 is a connected airway indicator marker 86. In the dialog box 80 of FIG. 8, this connected airway indicator marker 86 is shown in the form of the letter “A”, but it will be appreciated that other forms of marker could alternatively be used. In exemplary embodiments, the connected airway indicator marker 86 is shown if another airway is connected to the waypoint displayed in the dialog box in addition to the present airway along which the aircraft is traversing. For example, in the dialog box 86 shown in FIG. 8, connected airway indicator markers 86 are shown as being associated with waypoints “PMD” and “KIMMO”.

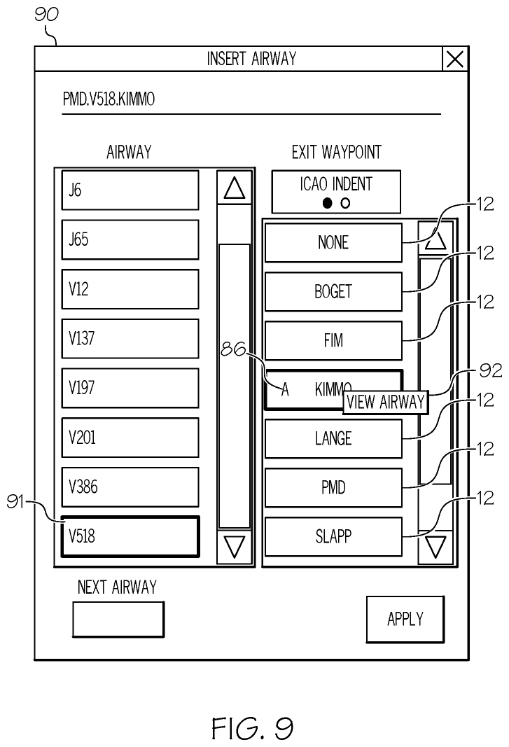

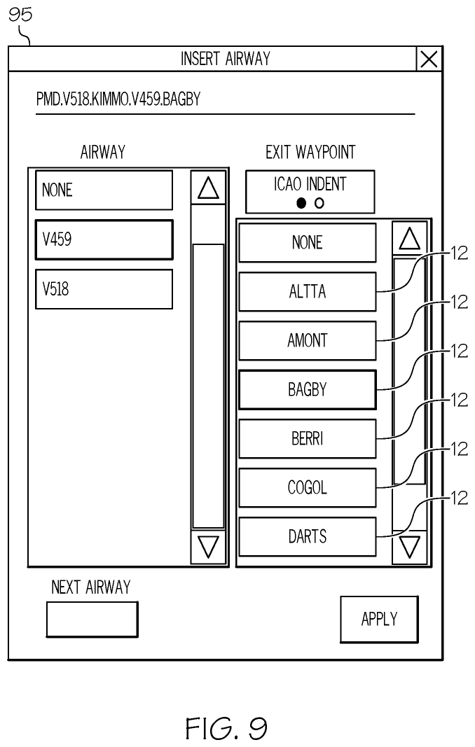

In exemplary embodiments, the dialog box 80 is displayed concurrently with the exemplary representation such that the pilot does not need to “switch” between viewing the information on the exemplary representation and the information in the dialog box 80. In exemplary embodiments, the pilot is able to interact with the dialog box 80 using the flight management system 104 to display the airway which is shown as being connected to a certain waypoint in the dialog box 80 on the exemplary representation, as will be explained in more detail with reference to FIGS. 9 and 10. In this manner, the pilot is able to efficiently construct a flight plan by sequentially selecting airways and waypoints with the benefit of the information graphically represented on the exemplary representation.

FIGS. 9 and 10 shows two versions of a dialog box 90, 95, that may be used by a pilot to modify the flight plan of the aircraft. As can be seen in FIG. 9, the aircraft is presently travelling along the highlighted airway 91 designated “V518”. The pilot is able to select from a list of designated waypoints 12 shown in the dialog box 90. In the scenario shown in FIG. 9, the pilot has selected the highlighted exit waypoint 12 designated “KIMMO”, which waypoint has a connected airway indicator marker 86.

When the pilot selects the airway having the connected airway indicator marker 86, the processor module 108 is configured to display a prompt 92 for the pilot to display the connected airway on the graphical representation 100. When the pilot uses the flight management system 104 to select the prompt 92, the associated connected airway is highlighted on the simultaneously displayed representation 400. By concurrently highlighting the connected airway on the graphical representation 100 when the prompt 92 is selected, the pilot is able to easily identify the connected airway on the graphical representation 100 and plot the modification in the flight plan with reduced effort.

In the scenario shown in FIG. 9, the airway connected to the waypoint designated “KIMMO” is the airway designated “V549”. The pilot is then able to select this subsequent airway “V549”, and this selection is concurrently shown on the simultaneously-displayed representation 100. In particular, the “KIMMO” waypoint is shown as the current designated waypoint on the graphical representation, and the airways connected to this waypoint are shown on the graphical representation. The pilot is then able to use the flight management system 104 to confirm the selection of this airway.

After selection of the subsequent airway “V549”, the processor module 108 is then configured to display, in the dialog box 95 shown in FIG. 10, the exit waypoints associated with that airway. As can be seen in FIG. 10, a list of exit waypoints 12 associated with the airway “V459” is shown in dialog box 95. The pilot is able to select each one of the associated exit waypoints. When an exit waypoint is selected in the dialog box 95, the exit waypoint is displayed on the exemplary representation.

In exemplary embodiments, waypoint performance data is also displayed concurrently with the list of exit waypoints, in the same manner as detailed above. The pilot may use the flight management system 104 to select a preferred exit waypoint 12. When the pilot selects a new preferred exit waypoint, that exit waypoint becomes the current designated waypoint on the graphical representation, and the airways connected to the new current designated waypoint are shown on the graphical representation.

In this manner, the pilot may select and confirm a sequential series of airways and subsequent exit waypoints in an intuitive manner, using the performance data associated with each waypoint and the visual information presented on the simultaneously-displayed exemplary representation.

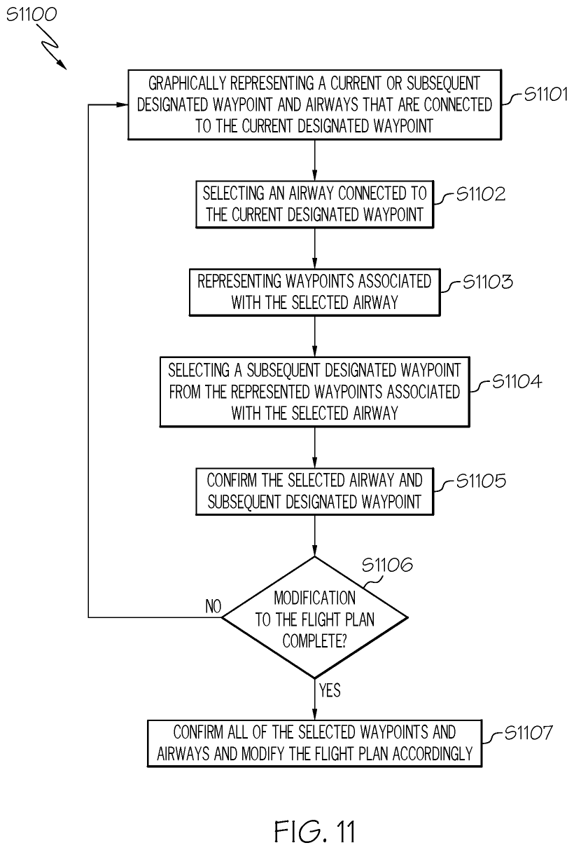

Referring now to FIG. 11, a flowchart of a method S1100 for modifying a pre-determined flight plan is shown.

At Step S1101, a graphical representation is created, using a processor module, showing a current designated waypoint and airways which are connected to the current designated waypoint. The graphical representation is displayed on a display module. The graphical representation further shows airways connected to the current designated waypoint, and the airway which forms part of the pre-determined flight plan is highlighted to the pilot in some manner. If the pilot wishes to modify the flight plan, the method progresses to step S1102.

At step S1102, the pilot selects, using a flight management system, an airway from the airways which are represented as being connected to the current designated waypoint. In exemplary embodiments, the pilot selects the airway from a dialog box displayed simultaneously with the graphical representation, the dialog box listing airways which are connected to the current designated waypoint. The method then progresses to step S1103.

At step S1103, waypoints associated with the selected airway are graphically represented, using the processor module, on the display module. In exemplary embodiments, the waypoints associated with the selected airway comprise exit waypoints for the selected airway. In exemplary embodiments, a dialog box showing performance data for each one of the waypoints associated with the selected airway is displayed simultaneously with the graphical representation of the waypoints associated with the selected airway. The method then progresses to step S1104.

At step S1104, the pilot is able to select, using the flight management system and on the basis of the graphical representation of the associated waypoints and, if shown, waypoint performance data, a subsequent designated waypoint for the selected airway. After the pilot selects a subsequent waypoint for the selected airway, the method progresses to step S1105.

At step S1105, the pilot confirms, using the flight management system, the selection of the selected airway and selected subsequent designated waypoint. The method then progresses to Step S1106.

At step S1106, the pilot can choose whether to further modify the flight plan. If the pilot wishes to further modify the flight plan, the method reverts to Step S1101, and the airways connected to the selected subsequent designated waypoint are graphically represented to the pilot, by the processor module, in the same manner the airways which were connected to the current designated waypoint were graphically represented to the pilot.

If the pilot does not want to further modify the flight plan, the pilot may, as step S1107, confirm all of the selected waypoints and airways to thereby modify the flight plan accordingly.

In this manner, the pilot may modify the flight plan by selecting a series of connected airways and associated waypoints on the basis of the graphical representation in an efficient and intuitive manner. In exemplary embodiments, the performance data and other navigational aid data shown alongside the graphical representation also assists the pilot in selecting an optimum waypoint from the list of waypoints associated with the selected airway.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

1. An avionic information system, comprising:
a flight management system for providing a current designated waypoint;
a navigation database storing waypoint location information and airway location information;
a display module; and
a processor module operably connected to the flight management system, the navigation database and the display module, wherein the processor module is configured to determine, from the stored waypoint location information and the stored airway location information, one or more airways that are connected to the current designated waypoint and to cause the display to graphically represent the current designated waypoint and only the determined one or more airways that are connected to the current designated waypoint and not other nearby airways.

2. The avionic information system of claim 1, wherein the flight management system is operable to select a subsequent designated waypoint from a list of waypoints in order to modify a pre-determined flight plan of the aircraft.

3. The avionic information system of claim 2, wherein the processor module is configured to cause the display module to display performance data related to each waypoint in the list of the waypoints.

4. The avionic information system of claim 3, wherein the performance data comprises performance data selected from the group consisting of fuel consumption required to reach the waypoint, the distance to the waypoint, the time required to reach the waypoint, and the fuel remaining after the waypoint is reached.

5. The avionic information system of claim 3, wherein the processor module is configured to cause the display module to display the change in performance data between different listed waypoints.

6. The avionic information system of claim 1, wherein the processor module is configured to cause the display module to display a vertical airway profile together with the current designated waypoint and the determined one or more airways that are connected to the current designated waypoint.

7. The avionic information system of claim 1, wherein the processor module is configured to cause the display module to display supplemental information on the display module in an area of the display module such that the supplemental information does not obscure the graphically represented current designated waypoint and the determined one or more airways that are connected to the current designated waypoint.

8. A method of modifying a pre-determined flight plan, the method comprising:
graphically representing on a display module, using a processor module, a current designated waypoint and only airways that are connected to the current designated waypoint and not other nearby airways;
selecting, using a flight management system, an airway connected to the current designated waypoint;
displaying on the display module, using the processor module, a list of potential subsequent designated waypoints and a graphical representation of the subsequent designated waypoints; and
selecting a subsequent designated waypoint from the list of potential subsequent designated waypoints.

9. The method of claim 8, further comprising displaying on the display module, using the processor module, performance data associated with each one of the subsequent designated waypoints.

10. The method of claim 9, wherein the performance data comprises performance data selected from the group consisting of fuel consumption required to reach the waypoint, a distance to the waypoint, a time required to reach the waypoint, and an amount of fuel remaining after the waypoint is reached.

11. The method of claim 9, further comprising displaying on the display module using the processor module, a change in performance data between different listed waypoints.

12. The method of claim 8, further comprising displaying on the display module, using the processor module, airway vertical profile information together with the current designated waypoint and airways that are connected to the current designated waypoint.

13. The method of claim 8, further comprising displaying on the display module, using the processor module, supplemental information on top of the graphical representation.

14. The method of claim 13, further comprising selecting, using the processor module, an area of the graphical representation to display the supplemental information such that the supplemental information does not obscure the displayed current designated waypoint and airways that are connected to the current designated waypoint.

15. (canceled)

16. (canceled)

17. (canceled)

18. (canceled)

19. (canceled)

20. An avionic information system, comprising:
a flight management system for providing a current designated waypoint;
a navigation database storing waypoint location information and airway location information;
a display module; and
a processor module operably connected to the flight management system, the navigation database and the display module, wherein the processor module is configured to, by a processor, determine, from the stored waypoint location information and the stored airway location information, one or more airways that are connected to the current designated waypoint and to cause the display to graphically represent the current designated waypoint and only the determined one or more airways that are connected to the current designated waypoint and not other nearby airways, wherein the processor module is configured to, by a processor, cause the display module to display a dialog box for use by flight crew to modify an existing flight plan on the display module in an area of the display module such that the dialog box does not obscure the graphically represented current designated waypoint and the determined one or more airways that are connected to the current designated waypoint.

21. The avionic information system of claim 20, wherein the flight management system is operable to select a subsequent designated waypoint from a list of waypoints in order to modify a pre-determined flight plan of the aircraft.

22. The avionic information system of claim 21, wherein the processor module is configured to, by a processor, cause the display module to display performance data related to each waypoint in the list of the waypoints.

23. The avionic information system of claim 22, wherein the performance data comprises performance data selected from the group consisting of fuel consumption required to reach the waypoint, the distance to the waypoint, the time required to reach the waypoint, and the fuel remaining after the waypoint is reached.

24. The avionic information system of claim 22, wherein the processor module is configured to, by a processor, cause the display module to display the change in performance data between different listed waypoints.

25. The avionic information system of claim 20, wherein the processor module is configured to, by a processor, cause the display module to display a vertical airway profile together with the current designated waypoint and the determined one or more airways that are connected to the current designated waypoint.
